(19) United States
(12) Patent Application Publication
(10) Pub. No.: US 2023/0395862 A1
(43) Pub. Date: Dec. 7, 2023

(54) ELECTROLYTE SOLUTION, PRODUCTION METHOD THEREFOR, AND SECONDARY BATTERY

(71) Applicant: MURATA MANUFACTURING CO., LTD., Kyoto (JP)

(72) Inventors: Yoshiaki SUZUKI, Kyoto (JP); Daisuke MORI, Kyoto (JP); Ryuhei MATSUMOTO, Kyoto (JP); Yuri NAKAYAMA, Kyoto (JP)

(21) Appl. No.: 18/236,152

(22) Filed: Aug. 21, 2023

Related U.S. Application Data
(63) Continuation of application No. PCT/JP2022/009540, filed on Mar. 4, 2022.

(30) Foreign Application Priority Data
Mar. 11, 2021 (JP) 2021-039334

(51) Int. Cl. H01M 10/0568; H01M 10/0569; H01M 10/052; H01M 4/38

(52) U.S. Cl. CPC H01M 10/0568; H01M 10/0569; H01M 10/052; H01M 4/382; H01M 2300/0034; H01M 2300/0037

(57) ABSTRACT

An electrolyte solution for a secondary battery is provided and includes an electrolyte and a solvent, in which the electrolyte contains a sulfonyl group-containing lithium salt and lithium nitrate, a total content of the sulfonyl group-containing lithium salt and the lithium nitrate is 0.8 mol/L or more and 2.0 mol/L or less, and the solvent contains a straight-chain ether and a fluorinated ether.

### CROSS REFERENCE TO RELATED APPLICATIONS

The present application is a continuation of PCT patent application no. PCT/JP2022/009540, filed on Mar. 4, 2022, which claims priority to Japanese patent application no. 2021-039334, filed on Mar. 11, 2021, the entire contents of which are incorporated herein by reference.

### BACKGROUND

The present application relates to an electrolyte solution, a production method therefor, and a secondary battery.

A typical secondary battery has a structure in which a positive electrode, a negative electrode, a separator, and an electrolyte solution are sealed in an outer casing. From the viewpoint of energy density, decreasing the amount of the electrolyte solution in such a secondary battery is desirable. In addition, cycle characteristics that reduce degradation of the discharge capacity despite repeated charging and discharging are also desirable.

However, decreasing the amount of the electrolyte solution raises the issue of lower discharge capacity.

Meanwhile, an attempt to improve charge-discharge characteristics is described by using an aqueous electrolyte solution that contains: a non-aqueous solvent selected from the group consisting of acyclic ethers, cyclic ethers, polyethers, and sulfones; a lithium salt; and a nitrile additive.

### SUMMARY

The present application relates to an electrolyte solution, a production method therefor, and a secondary battery.

There is need to address the following issues, for example:
(1) Decreasing the amount of the electrolyte solution raises the issue of insufficient discharge capacity from the initial discharging.
(2) Repeated charging and discharging decreases the discharge capacity, and sufficient cycle characteristics have not been obtained.

The present application, in an embodiment, relates to providing an electrolyte solution that provides sufficient discharge characteristics and/or cycle characteristics despite the decreased amount of the electrolyte solution.

The present application, in an embodiment, relates to an electrolyte solution for a secondary battery, the electrolyte solution containing an electrolyte and a solvent,

in which the electrolyte contains a sulfonyl group-containing lithium salt and lithium nitrate,

a total content of the sulfonyl group-containing lithium salt and the lithium nitrate is 0.8 mol/L or more and 2.0 mol/L or less, and

the solvent contains a straight-chain ether and a fluorinated ether.

A secondary battery that includes an electrolyte solution of the present application, in an embodiment, exhibits sufficient discharge capacity from the initial discharging despite the decreased amount of the electrolyte solution.

The secondary battery that includes the electrolyte solution of the present application, in an embodiment, also has sufficient cycle characteristics.

### BRIEF DESCRIPTION OF THE FIGURES

FIG. 1 is a graph showing initial discharge curves of secondary batteries that include the electrolyte solutions prepared in Examples 1 and 2 and Comparative Example 1.

FIG. 2 is a graph showing the relationship between the dilution rate and the initial discharge capacities of the secondary batteries that include the electrolyte solutions prepared in Examples 1 and 2 and Comparative Example 1.

FIG. 3 is a graph showing the relationship between the number of cycles and the discharge capacities of the secondary batteries prepared by using the electrolyte solutions of Example 1 and Comparative Example 1.

FIG. 4 is a schematic cross-sectional view of a secondary battery (cylindrical secondary battery) according to an embodiment of the present application.

FIG. 5 is a schematic perspective view of a secondary battery (flat plate-type laminate film-type secondary battery) according to an embodiment of the present application.

### DETAILED DESCRIPTION

The present relates to battery technology, such as a secondary battery, and will be described in further detail below according to an embodiment. In the present description, the term secondary battery refers to any suitable battery that can be repeatedly charged and discharged including, for example, electrochemical devices such as power storage devices according to an embodiment.

The secondary battery, in an embodiment, includes a positive electrode, a negative electrode, and an electrolyte solution, and typically further includes a separator interposed between the positive electrode and the negative electrode. In the secondary battery, a positive electrode, a negative electrode, an electrolyte solution, a separator, etc., are sealed in an outer casing or housing according to an embodiment.

The electrolyte solution is a non-aqueous electrolyte solution. A non-aqueous electrolyte solution refers to an electrolyte solution in which water is not contained in a medium in which electrolyte ions travel, in other words, an electrolyte solution that uses only an organic solvent as the medium.

In an embodiment, the electrolyte solution contains an electrolyte and a solvent.

In an embodiment, the electrolyte in the electrolyte solution contains a sulfonyl group-containing lithium salt and a lithium nitrate. When the electrolyte does not contain one or both of the sulfonyl group-containing lithium salt and lithium nitrate, sufficient discharge characteristics and/or sufficient cycle characteristics might not be obtained. A sulfonyl group-containing lithium salt, such as LiTFSI, that has a high degree of dissociation is necessary to enable dissolution in a straight-chain ether, and redox shuttles occur in the absence of lithium nitrate. Since the electrolyte is dissolved in a solvent in the electrolyte solution, the electrolyte solution takes a form of a solution. A solution refers to a state or mode in which the electrolyte is evenly dispersed on a molecular level in a solvent to an extent that the electrolyte solution appears transparent to a naked eye at room temperature (for example, 25° C.)

As described herein, discharge characteristics refer to characteristics with which a sufficient discharge capacity is obtained from the initial discharging.

Cycle characteristics refer to characteristics with which the discharge capacity is sufficiently retained despite repeated charging and discharging.

The sulfonyl group-containing lithium salt is an organic lithium salt that has a sulfonyl group (—SO₂—) in its molecular structure. Specific examples of the sulfonyl group-containing lithium salt include at least one compound selected from the group consisting of sulfonylimide lithium salts represented by general formula (S1) below and lithium sulfonates represented by general formula (S2) below. The sulfonyl group-containing lithium salt is preferably a sulfonylimide lithium salt represented by general formula (S1) below from the viewpoint of further improving the discharge characteristics and the cycle characteristics.

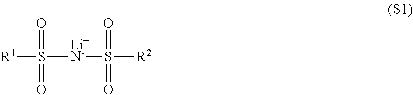

In formula (S1), R¹ and R² are each independently a halogen atom or a halogen atom-containing hydrocarbon group having 1 to 10 carbon atoms, and, from the viewpoint of further improving the discharge characteristics and the cycle characteristics, are preferably each independently a halogen atom or a halogen atom-containing hydrocarbon group having 1 to 5 carbon atoms and more preferably a halogen atom-containing hydrocarbon group having 1 to 3 carbon atoms. For R¹ and R², the halogen atom-containing hydrocarbon group is a monovalent hydrocarbon group, may be a saturated aliphatic hydrocarbon group, an unsaturated aliphatic hydrocarbon group, or an aromatic hydrocarbon group as long as a halogen atom is contained, and, from the viewpoint of further improving the discharge characteristics and the cycle characteristics, is preferably a saturated aliphatic hydrocarbon group (alkyl group). The number of halogen atoms contained in the halogen atom-containing hydrocarbon group is not particularly limited as long as at least one of hydrogen atoms in the hydrocarbon group is substituted with a halogen atom. The halogen atom-containing hydrocarbon group preferably has all hydrogen atoms in the hydrocarbon group substituted with halogen atoms from the viewpoint of further improving the discharge characteristics and the cycle characteristics. The halogen atoms may be fluorine atoms, chlorine atoms, or bromine atoms, and are preferably fluorine atoms from the viewpoint of further improving the discharge characteristics and the cycle characteristics. When the halogen atom-containing hydrocarbon group is a saturated aliphatic hydrocarbon group and all of the hydrogen atoms thereof are substituted with fluorine atoms, the halogen atom-containing hydrocarbon group can be referred to as a perfluoroalkyl group. For R¹ and R², examples of the preferable halogen atom-containing hydrocarbon group include a perfluoromethyl group, a perfluoroethyl group, a perfluoropropyl group, a perfluorobutyl group, and a perfluoropentyl group. R¹ and R² are preferably the same group from the viewpoint of further improving the discharge characteristics and the cycle characteristics.

Examples of the compounds represented by general formula (S1) (also referred to as the compounds (S1) or sulfonylimide lithium salts (S1)) are as follows.

TABLE 1
Specific examples of compound (S1)

| Compound | R¹ | R² |
|---|---|---|
| s1-1 | Fluorine atom | Fluorine atom |
| s1-2 | Perfluoromethyl group | Perfluoromethyl group |
| s1-3 | Perfluoroethyl group | Perfluoroethyl group |
| s1-4 | Perfluoropropyl group | Perfluoropropyl group |
| s1-5 | Perfluorobutyl group | Perfluorobutyl group |

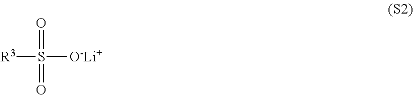

In formula (S2), R³ is a halogen atom or a halogen atom-containing hydrocarbon group having 1 to 10 carbon atoms, and, from the viewpoint of further improving the discharge characteristics and the cycle characteristics, is preferably a halogen atom or a halogen atom-containing hydrocarbon group having 1 to 5 carbon atoms and more preferably a halogen atom-containing hydrocarbon group having 1 to 3 carbon atoms. As with the halogen atom-containing hydrocarbon groups for R¹ and R², the halogen atom-containing hydrocarbon group for R³ is a monovalent hydrocarbon group, may be a saturated aliphatic hydrocarbon group, an unsaturated aliphatic hydrocarbon group, or an aromatic hydrocarbon group as long as a halogen atom is contained, and, from the viewpoint of further improving the discharge characteristics and the cycle characteristics, is preferably a saturated aliphatic hydrocarbon group (alkyl group). The number of halogen atoms contained in the halogen atom-containing hydrocarbon group is not particularly limited as long as at least one of hydrogen atoms in the hydrocarbon group is substituted with a halogen atom. The halogen atom-containing hydrocarbon group preferably has all hydrogen atoms in the hydrocarbon group substituted with halogen atoms from the viewpoint of further improving the discharge characteristics and the cycle characteristics. The halogen atoms may be fluorine atoms, chlorine atoms, or bromine atoms, and are preferably fluorine atoms from the viewpoint of further improving the discharge characteristics and the cycle characteristics. When the halogen atom-containing hydrocarbon group is a saturated aliphatic hydrocarbon group and all of the hydrogen atoms thereof are substituted with fluorine atoms, the halogen atom-containing hydrocarbon group can be referred to as a perfluoroalkyl group. For R³, examples of the preferable halogen atom-containing hydrocarbon group include the same preferable halogen atom-containing hydrocarbon groups for R¹ and R².

Examples of the compounds represented by general formula (S2) (also referred to as the compounds (S2) or lithium sulfonates (S2)) are as follows.

TABLE 2
Specific examples of compound (S2)

| Compound | R³ |
|---|---|
| s2-1 | Fluorine atom |
| s2-2 | Perfluoromethyl group |
| s2-3 | Perfluoroethyl group |
| s2-4 | Perfluoropropyl group |
| s2-5 | Perfluorobutyl group |

Sulfonyl group-containing lithium salts are available as commercial products.

For example, a compound (s1-1) is available as LiFSI (produced by NIPPON SHOKUBAI CO., LTD.).

For example, a compound (s1-2) is available as LiTFSI (produced by TOMIYAMA PURE CHEMICAL INDUSTRIES, LTD.).

For example, a compound (s1-3) is available as LiBETI (produced by Iolitec Ionic Liquids Technologies GmbH).

For example, a compound (s1-5) is available as LiN(C4F9SO2)2 (produced by Mitsubishi Materials Electronic Chemicals Co., Ltd.).

For example, a compound (s2-2) is available as LiCF3SO3 (produced by FUJIFILM Wako Pure Chemical Corporation).

For example, a compound (s2-5) is available as LiC4F9SO3 (produced by FUJIFILM Wako Pure Chemical Corporation).

The sulfonyl group-containing lithium salt content is not particularly limited as long as the total content of the sulfonyl group-containing lithium salt and lithium nitrate is within the range described below, and is, from the viewpoint of further improving the discharge characteristics and the cycle characteristics, preferably 0.1 mol/L or more and 1.0 mol/L or less, more preferably 0.2 mol/L or more and mol/L or less, yet more preferably 0.3 mol/L or more and mol/L or less, still more preferably 0.4 mol/L or more and 0.8 mol/L or less, and most preferably 0.4 mol/L or more and 0.6 mol/L or less, and this sulfonyl group-containing lithium salt may contain two or more compounds having different structures, in which case the total content thereof is to be within the aforementioned range. Here, the unit “mol/L” refers to the number of moles contained per liter of the electrolyte solution.

The lithium nitrate content is not particularly limited as long as the total content of the sulfonyl group-containing lithium salt and lithium nitrate is within the range described below, and is, from the viewpoint of further improving the discharge characteristics and the cycle characteristics, preferably 0.1 mol/L or more and 1.0 mol/L or less, more preferably 0.2 mol/L or more and 0.9 mol/L or less, yet more preferably 0.3 mol/L or more and 0.9 mol/L or less, still more preferably 0.4 mol/L or more and 0.8 mol/L or less, and most preferably 0.4 mol/L or more and 0.6 mol/L or less.

The total content of the sulfonyl group-containing lithium salt and lithium nitrate is 0.8 mol/L or more and 2.0 mol/L or less, and, from the viewpoint of further improving the discharge characteristics and the cycle characteristics, is preferably 0.8 mol/L or more and 1.8 mol/L or less, more preferably 0.8 mol/L or more and 1.6 mol/L or less, and still more preferably 0.9 mol/L or more and 1.2 mol/L or less. When this total content is excessively large, the electrical conductivity decreases due to the increased viscosity. When this total content is excessively small, the electrical conductivity decreases and the amount of the polysulfide elution increases. As a result, sufficient discharge characteristics and/or sufficient cycle characteristics might not be obtained. The sulfonyl group-containing lithium salt may contain two or more compounds having different structures, in which case the total of the contents of the two or more compounds and lithium nitrate is to be within the aforementioned range.

The present application does not exclude the cases in which the electrolyte solution contains electrolytes (may also be referred to as additional electrolytes in the description below) other than the sulfonyl group-containing lithium salt and lithium nitrate. The additional electrolyte content is usually smaller than or equal to the smaller of the sulfonyl group-containing lithium salt content and the lithium nitrate content, and may be, for example, 1 mol/L or less, in particular, 0.5 mol/L or less. The additional electrolyte content is preferably as small as possible including, for example, 0 mol/L from the viewpoint of further improving the discharge characteristics and the cycle characteristics.

In an embodiment, the solvent in the electrolyte solution contains a straight-chain ether and a fluorinated ether. When the solvent does not contain one or both of the straight-chain ether and the fluorinated ether, sufficient discharge characteristics and/or sufficient cycle characteristics might not be obtained.

The straight-chain ether may be any straight-chain ether used as a glyme solvent in the field of secondary batteries. Examples of the straight-chain ether include at least one compound selected from the group consisting of straight-chain ethers represented by general formula (G) below. The straight-chain ether includes at least the moiety having an ethyleneoxy structure unit that is not branched (in other words, there is no branching structure). Thus, R′ and R″ in general formula (G) below may have a branching structure. In a preferred embodiment, the straight-chain ether used in the electrolyte solution of the present application has an ethyleneoxy structure unit moiety free of a branching structure and also R′ and R″ are glycol ethers free of branching structures.

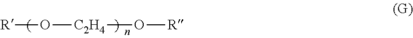

In formula (G), R′ and R″ are each independently a hydrocarbon group having 1 to 10 carbon atoms, and, from the viewpoint of further improving the discharge characteristics and the cycle characteristics, are preferably each independently a hydrocarbon group having 1 to 5 carbon atoms and more preferably a hydrocarbon group having 1 to 3 carbon atoms. For R′ and R″, the hydrocarbon group is a monovalent hydrocarbon group, may be a saturated aliphatic hydrocarbon group, an unsaturated aliphatic hydrocarbon group, or an aromatic hydrocarbon group, and, from the viewpoint of further improving the discharge characteristics and the cycle characteristics, is preferably a saturated aliphatic hydrocarbon group (alkyl group). For R′ and R″, examples of the preferable hydrocarbon groups include a methyl group, an ethyl group, a propyl group, a butyl group, a pentyl group, a hexyl group, a heptyl group, an octyl group, a nonyl group, and a decyl group. R′ and R″ are preferably the same group from the viewpoint of further improving the discharge characteristics and the cycle characteristics.

Here, n is an integer of 1 or more and 10 or less, and, from the viewpoint of further improving the discharge characteristics and the cycle characteristics, is preferably an integer of 1 or more and 5 or less, more preferably an integer of 1 or more and 3 or less, and yet more preferably 1.

Examples of such a straight-chain ether include ethylene glycol ethers, diethylene glycol ethers, triethylene glycol ethers, and tetraethylene glycol ethers. From the viewpoint of further improving the discharge characteristics and the cycle characteristics, ethylene glycol ethers (in particular, monoglyme), diethylene glycol ethers (in particular, diglyme), or mixtures thereof are preferable, and ethylene glycol ethers (in particular, monoglyme) are more preferable.

Examples of the ethylene glycol ethers are the following compounds:

ethylene glycol dimethyl ether (dimethoxyethane; monoglyme), ethylene glycol ethyl methyl ether, ethylene glycol methyl propyl ether, ethylene glycol butyl methyl ether, ethylene glycol methyl pentyl ether, ethylene glycol methyl hexyl ether, ethylene glycol methyl heptyl ether, and ethylene glycol methyl octyl ether;

ethylene glycol diethyl ether, ethylene glycol ethyl propyl ether, ethylene glycol butyl ethyl ether, ethylene glycol ethyl pentyl ether, ethylene glycol ethyl hexyl ether, ethylene glycol ethyl heptyl ether, and ethylene glycol ethyl octyl ether; and

ethylene glycol dipropyl ether, ethylene glycol butyl propyl ether, ethylene glycol propyl pentyl ether, ethylene glycol propyl hexyl ether, ethylene glycol propyl heptyl ether, and ethylene glycol propyl octyl ether.

Examples of the diethylene glycol ethers are the following compounds:

diethylene glycol dimethyl ether (diglyme), diethylene glycol ethyl methyl ether, diethylene glycol methyl propyl ether, diethylene glycol butyl methyl ether, diethylene glycol methyl pentyl ether, diethylene glycol methyl hexyl ether, diethylene glycol methyl heptyl ether, and diethylene glycol methyl octyl ether;

diethylene glycol diethyl ether, diethylene glycol ethyl propyl ether, diethylene glycol butyl ethyl ether, diethylene glycol ethyl pentyl ether, diethylene glycol ethyl hexyl ether, diethylene glycol ethyl heptyl ether, and diethylene glycol ethyl octyl ether; and

diethylene glycol dipropyl ether, diethylene glycol butyl propyl ether, diethylene glycol propyl pentyl ether, diethylene glycol propyl hexyl ether, diethylene glycol propyl heptyl ether, and diethylene glycol propyl octyl ether.

Examples of the triethylene glycol ethers are the following compounds:

triethylene glycol dimethyl ether (triglyme), triethylene glycol ethyl methyl ether, triethylene glycol methyl propyl ether, triethylene glycol butyl methyl ether, triethylene glycol methyl pentyl ether, triethylene glycol methyl hexyl ether, triethylene glycol methyl heptyl ether, and triethylene glycol methyl octyl ether;

triethylene glycol diethyl ether, triethylene glycol ethyl propyl ether, triethylene glycol butyl ethyl ether, triethylene glycol ethyl pentyl ether, triethylene glycol ethyl hexyl ether, triethylene glycol ethyl heptyl ether, and triethylene glycol ethyl octyl ether; and

triethylene glycol dipropyl ether, triethylene glycol butyl propyl ether, triethylene glycol propyl pentyl ether, triethylene glycol propyl hexyl ether, triethylene glycol propyl heptyl ether, and triethylene glycol propyl octyl ether.

Examples of the tetraethylene glycol ethers are the following compounds:

tetraethylene glycol dimethyl ether (tetraglyme), tetraethylene glycol ethyl methyl ether, tetraethylene glycol methyl propyl ether, tetraethylene glycol butyl methyl ether, tetraethylene glycol methyl pentyl ether, tetraethylene glycol methyl hexyl ether, tetraethylene glycol methyl heptyl ether, and tetraethylene glycol methyl octyl ether;

tetraethylene glycol diethyl ether, tetraethylene glycol ethyl propyl ether, tetraethylene glycol butyl ethyl ether, tetraethylene glycol ethyl pentyl ether, tetraethylene glycol ethyl hexyl ether, tetraethylene glycol ethyl heptyl ether, and tetraethylene glycol ethyl octyl ether; and

tetraethylene glycol dipropyl ether, tetraethylene glycol butyl propyl ether, tetraethylene glycol propyl pentyl ether, tetraethylene glycol propyl hexyl ether, tetraethylene glycol propyl heptyl ether, and tetraethylene glycol propyl octyl ether.

Straight-chain ethers are available as commercial products.

For example, dimethoxyethane (monoglyme) is available from TOMIYAMA PURE CHEMICAL INDUSTRIES, LTD.

For example, diglyme is available as a product of TOMIYAMA PURE CHEMICAL INDUSTRIES, LTD.

For example, triglyme is available as a product of TOMIYAMA PURE CHEMICAL INDUSTRIES, LTD.

For example, tetraglyme is available as a product of TOMIYAMA PURE CHEMICAL INDUSTRIES, LTD.

The straight-chain ether content may be any as long as the fluorinated ether content relative to the total amount of the straight-chain ether and the fluorinated ether is within the range mentioned below. The straight-chain ether may contain two or more straight-chain ethers having different structures, and, in such a case, the total content thereof is to be within the aforementioned range.

The fluorinated ether is a straight-chain or cyclic ether compound that has a fluorine atom and an ether bond. Specifically, the fluorinated ether is at least one compound selected from the group consisting of straight-chain ether compounds represented by general formula (E1) below and cyclic ether compounds represented by general formula (E2) below. The fluorinated ether is preferably a straight-chain ether compound represented by general formula (E1) below from the viewpoint of further improving the discharge characteristics and the cycle characteristics. The straight-chain ether compound has a structure that can be represented by general formula (E1). Specifically, R¹¹, R¹², and R¹³ in general formula (E1) below do not have to have a straight-chain structure and may have a branching structure. In one preferred embodiment, the fluorinated ether used in the electrolyte solution in the present application is a fluorinated ether that has a structure that can be represented by general formula (E1) below with R¹¹, R¹², and R¹³ free of branching structures.

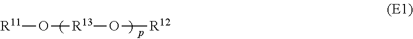

In formula (E1), at least one selected from R¹¹ and R¹² is a fluorine atom-containing monovalent hydrocarbon group having 1 to 10 carbon atoms, and, from the viewpoint of further improving the discharge characteristics and the cycle characteristics, is preferably a fluorine atom-containing monovalent hydrocarbon group having 1 to 5 carbon atoms and more preferably a fluorine atom-containing monovalent hydrocarbon group having 1 to 3 carbon atoms. For R¹¹ and R¹², the fluorine atom-containing monovalent hydrocarbon group may be a saturated aliphatic monovalent hydrocarbon group, an unsaturated aliphatic monovalent hydrocarbon group, or an aromatic monovalent hydrocarbon group, and from the viewpoint of further improving the discharge characteristics and the cycle characteristics, is preferably a saturated aliphatic monovalent hydrocarbon group (alkyl group). The number of fluorine atoms contained in the fluorine atom-containing monovalent hydrocarbon group is not particularly limited as long as at least one of hydrogen atoms in the hydrocarbon group is substituted with a halogen atom. From the viewpoint of further improving the discharge characteristics and the cycle characteristics, the number of the fluorine atoms in the fluorine atom-containing monovalent hydrocarbon group is preferably one half or more of the total number of all hydrogen atoms and fluorine atoms contained in the fluorine atom-containing monovalent hydrocarbon group. When R¹¹ and R¹² are both the fluorine atom-containing monovalent hydrocarbon groups, R¹¹ and R¹² may represent the same group or different groups.

The fluorine atom-containing monovalent hydrocarbon group is specifically a hydrocarbon group represented by general formula (F) below.

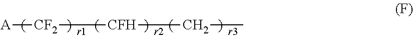

In formula (F), A is a hydrogen atom or a fluorine atom, and, from the viewpoint of further improving the discharge characteristics and the cycle characteristics, is a hydrogen atom.

Here, r1 is an integer of 0 or more and 10 or less, and, from the viewpoint of further improving the discharge characteristics and the cycle characteristics, is preferably an integer of 1 or more and 10 or less, more preferably an integer of 1 or more and 5 or less, yet more preferably an integer of 1 or more and 3 or less, still more preferably 1 or 2, and most preferably 2.

Here, r2 is an integer of 0 or more and 10 or less, and, from the viewpoint of further improving the discharge characteristics and the cycle characteristics, is preferably an integer of 0 or more and 5 or less, more preferably an integer of 0 or more and 3 or less, yet more preferably an integer of 0 or more and 2 or less, particularly preferably 0 or 1, and most preferably 0.

Here, r3 is an integer of 0 to 9, and, from the viewpoint of further improving the discharge characteristics and the cycle characteristics, is preferably an integer of 0 to 5, more preferably an integer of 0 to 3, yet more preferably an integer of 0 to 2, and still more preferably 0 or 1.

Here, r1+r2 is an integer of 1 or more and 10 or less, and, from the viewpoint of further improving the discharge characteristics and the cycle characteristics, is preferably an integer of 1 or more and 5 or less, more preferably an integer of 1 or more and 3 or less, yet more preferably 2 or 3, and still more preferably 2.

Here, r1+r2+r3 is an integer of 1 or more and 10 or less, and, from the viewpoint of further improving the discharge characteristics and the cycle characteristics, is preferably an integer of 1 or more and 6 or less, more preferably an integer of 1 or more and 5 or less, yet more preferably an integer of 1 or more and 3 or less, and still more preferably 2 or 3.

In formula (F), difluoroethylene units related to r1, monofluoroethylene units related to r2, and ethylene units related to r3 are each arranged continuously to form a block; however, the arrangement is not limited to this and may be random. From the viewpoint of further improving the discharge characteristics and the cycle characteristics, these units are preferably each arranged continuously in the order recited in formula (F) so as to form a block.

In formula (E1), when only one of R¹¹ and R¹² is a fluorine atom-containing monovalent hydrocarbon group, the other is a monovalent hydrocarbon group having 1 to 10 carbon atoms, and, from the viewpoint of further improving the discharge characteristics and the cycle characteristics, is preferably a monovalent hydrocarbon group having 1 to 5 carbon atoms and more preferably a monovalent hydrocarbon group having 1 to 3 carbon atoms. This monovalent hydrocarbon group may be a saturated aliphatic hydrocarbon group, an unsaturated aliphatic hydrocarbon group, or an aromatic hydrocarbon group, and from the viewpoint of further improving the discharge characteristics and the cycle characteristics, is preferably a saturated aliphatic hydrocarbon group (alkyl group). Examples of the monovalent hydrocarbon group include a methyl group, an ethyl group, a propyl group, a butyl group, a pentyl group, a hexyl group, a heptyl group, an octyl group, a nonyl group, and a decyl group.

In formula (E1), R¹³ is a divalent hydrocarbon group having 2 to 4 carbon atoms, and, from the viewpoint of further improving the discharge characteristics and the cycle characteristics, is preferably a divalent hydrocarbon group having 2 or 3 carbon atoms and more preferably a divalent hydrocarbon group having 2 carbon atoms. The divalent hydrocarbon group is a saturated aliphatic divalent hydrocarbon group, and examples thereof include an ethylene group, a propylene group, and a butylene group.

In formula (E1), p is an integer of 0 or 1. From the viewpoint of further improving the discharge characteristics and the cycle characteristics, p is preferably 0.

Examples of the compounds represented by general formula (E1) (may also be referred to as the compounds (E1) or straight-chain ether compounds (E1)) are compounds represented by general formulae (e1-1) and (e1-2) below.

R¹¹-0-R¹² (e1-1)

In formula (e1-1), R¹¹ and R¹² are the same as R¹¹ and R¹² in formula (E1). Thus, the fluorine atom-containing monovalent hydrocarbon groups related to R¹¹ and R¹² in formula (e1-1) are the same as the fluorine atom-containing monovalent hydrocarbon groups related to R¹¹ and R¹² in formula (E1).

Examples of R¹¹ and R¹² in formula (e1-1) are also the same as the preferable examples of R¹¹ and R¹² in formula (E1). Examples of the fluorine atom-containing monovalent hydrocarbon group related to R¹¹ and R¹² in formula (e1-1) are also the same as the fluorine atom-containing monovalent hydrocarbon groups related to R¹¹ and R¹² in formula (E1).

Examples of the compounds represented by general formula (e1-1) (may also be referred to as the compounds (e1-1) or ether compounds (e1-1)) are the following compounds.

TABLE 3
Specific examples of compound (e1-1)

| Compound | R¹¹ | R¹² |
|---|---|---|
| e1-1-1 | HCF₂CF₂CH₂— | —CF₂CFHCF₃ |
| e1-1-2 | HCF₂CF₂CH₂— | —CF₂CF₂H |
| e1-1-3 | CF₃CF₂CH₂— | —CF₂CF₂H |
| e1-1-4 | HCF₂CF₂— | —C₃H₇ |
| e1-1-5 | HCF₂CF₂CH₂— | —C₂H₅— |
| e1-1-6 | (CH₃)₂CHCH₂— | —CF₂CF₂H |

The compounds (e1-1) are commercially available or can be synthesized by known methods.

For example, a compound (e1-1-1) is available from Manchester Organics Ltd.

For example, a compound (e1-1-2) is available from Manchester Organics Ltd.

For example, a compound (e1-1-3) is available from Manchester Organics Ltd.

For example, a compound (e1-1-4) is available from Angene.

R¹¹-0-R¹³-0-R¹² (e1-2)

In formula (e1-2), R¹¹, R¹², and R¹³ are the same as R¹¹, R¹², and R¹³ in formula (E1). Thus, the fluorine atom-containing monovalent hydrocarbon groups related to R¹¹ and R¹² in formula (e1-2) are the same as the fluorine atom-containing monovalent hydrocarbon groups related to R¹¹ and R¹² in formula (E1). The divalent hydrocarbon groups related to R¹³ in formula (e1-2) are also the same as the divalent hydrocarbon groups related to R¹³ in formula (E1).

Examples of R¹¹, R¹², and R¹³ in formula (e1-2) are also the same as the preferable examples of R¹¹, R¹², and R¹³ in formula (E1). Examples of the fluorine atom-containing monovalent hydrocarbon groups related to R¹¹ and R¹² in formula (e1-2) are also the same as the fluorine atom-containing monovalent hydrocarbon groups related to R¹¹ and R¹² in formula (E1). Examples of the divalent hydrocarbon groups related to R¹³ in formula (e1-2) are also the same as the divalent hydrocarbon group related to R¹³ in formula (E1).

A specific example of the compounds represented by general formula (e1-2) (may also be referred to as the compounds (e1-2) or glycol ether compounds (e1-2)) is the following compound.

TABLE 4
Specific example of compound (e1-2)

| Compound | R¹¹ | R¹³ | R¹² |
|---|---|---|---|
| e1-2-1 | CF₃CH₂— | —CH₂CH₂— | —CH₃ |

The compounds (e1-2) are commercially available or can be synthesized by known methods.

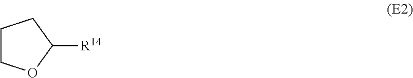

In formula (E2), R¹⁴ is a fluorine atom-containing monovalent hydrocarbon group having 1 to 10 carbon atoms, and is the same as R¹¹ and R¹² in formula (E1). Thus, the fluorine atom-containing monovalent hydrocarbon groups related to R¹⁴ in formula (E2) are the same as the fluorine atom-containing monovalent hydrocarbon groups related to R¹¹ and R¹² in formula (E1).

Examples of R¹⁴ in formula (E2) are also the same as the preferable examples of R¹¹ and R¹² in formula (E1). Examples of the fluorine atom-containing monovalent hydrocarbon groups related to R¹⁴ in formula (E2) are also the same as the fluorine atom-containing monovalent hydrocarbon groups related to R¹¹ and R¹² in formula (E1).

A specific example of the compounds represented by general formula (E2) (may also be referred to as the compounds (E2) or cyclic ether compounds (E2)) is the following compound.

TABLE 5
Specific example of compound (E2)

| Compound | R¹⁴ |
|---|---|
| e2-1 | —CF₂CFHCF₃ |

The compounds (e2-1) are commercially available or can be synthesized by known methods.

For example, a compound (e2-1) is available from Manchester Organics Ltd.

The viscosity of the fluorinated ether is not particularly limited and may be, for example, 0.1 mPa or more and 3.0 mPa or less, and, from the viewpoint of further improving the discharge characteristics and the cycle characteristics, is preferably 0.5 mPa or more and 2.5 mPa or less and more preferably 1.0 mPa or more and 2.5 mPa or less.

The permittivity of the fluorinated ether is not particularly limited and, for example, may be 3 or more and 20 or less, and, from the viewpoint of further improving the discharge characteristics and the cycle characteristics, is preferably 4 or more and 18 or less and more preferably 5 or more and 10 or less.

The boiling point of the fluorinated ether is not particularly limited, and may be, for example, 50° C. or higher and 150° C. or lower, and from the viewpoint of further improving the discharge characteristics and the cycle characteristics, is preferably 60° C. or higher and 120° C. or lower and more preferably 80° C. or higher and 110° C. or lower.

The fluorinated ether content is not particularly limited, and, from the viewpoint of further improving the discharge characteristics and the cycle characteristics, the content relative to the total amount of the straight-chain ether and the fluorinated ether is preferably 20 vol % or more and 60 vol % or less, more preferably 20 vol % or more and 55 vol % or less, yet more preferably 40 vol % or more and vol % or less, and still more preferably 45 vol % or more and 55 vol % or less. The fluorinated ether may contain two or more fluorinated ethers having different structures, and, in such a case, the total content thereof is to be within the aforementioned range.

The straight-chain ether and the fluorinated ether are contained as main solvents in the electrolyte solution. The total content of the straight-chain ether and the fluorinated ether relative to the total amount of the electrolyte solution is usually 80 vol % or more, and, from the viewpoint of further improving the discharge characteristics and the cycle characteristics, is preferably vol % or more, more preferably 98 vol % or more, and yet more preferably 100 vol %. Each of the straight-chain ether and the fluorinated ether may contain two or more ethers having different structures, and, in such a case, the total content thereof is to be within the aforementioned range.

The electrolyte solution may include one or more additional solventsin addition to the straight-chain ether and the fluorinated ether. The additional solvent content is usually smaller than or equal to the smallest content among the straight-chain ether contents, and, from the viewpoint of further improving the discharge characteristics and the cycle characteristics, is preferably 20 vol % or less, more preferably 10 vol % or less, and yet more preferably 2 vol % or less relative to the total amount of the electrolyte solution. The additional solvent content is preferably as small as possible and including, for example, 0 vol % from the viewpoint of further improving the discharge characteristics and the cycle characteristics.

The electrolyte solution may contain additives such as LiPF6, LiAsF6, LiBOB, LiDFOB, LiI, R—SH (thiol), P2S5, and Li2Sn (lithium polysulfide).

The additive content is not particularly limited, and may be, for example, 1 w/v % or less, in particular, 0.5 w/v % or less. The additive content is preferably as small as possible and including, for example, 0 w/v % from the viewpoint of further improving the discharge characteristics and the cycle characteristics. The additive may contain two or more additives, and, in such a case, the total content thereof is to be within the aforementioned range. Here, the unit “w/v %” refers the number grams contained per 100 mL of the electrolyte solution.

The electrolyte solution can be produced by dissolving a sulfonyl group-containing lithium salt and lithium nitrate in a straight-chain ether and then diluting the resulting solution with a fluorinated ether to adjust the total content of the sulfonyl group-containing lithium salt and the lithium nitrate to be in the range described above.

The electrolyte solution is not obtained by trying to produce an electrolyte solution by adding a sulfonyl group-containing lithium salt and lithium nitrate to a fluorinated ether, mixing the resulting mixture, and then diluting the resulting mixture with a straight-chain ether. This is because the sulfonyl group-containing lithium salt and lithium nitrate remain undissolved.

The electrolyte solution is not obtained by trying to produce an electrolyte solution by adding a sulfonyl group-containing lithium salt and lithium nitrate to a mixed solvent of a straight-chain ether and a fluorinated ether and then mixing the resulting mixture. This is also because the sulfonyl group-containing lithium salt and lithium nitrate remain undissolved.

The dilution rate of the fluorinated ether may be any rate as long as the fluorinated ether content relative to the total amount of the straight-chain ether and the fluorinated ether in the electrolyte solution is within the aforementioned range. The dilution rate is preferably 20% or more and 60% or less, more preferably 20% or more and 55% or less, yet more preferably 40% or more and 55% or less, and still more preferably 45% or more and 55% or less.

In this description, the dilution rate refers to a ratio (in particular volume ratio) of the amount of the solvent used in dilution added relative to the total solvent amount after dilution.

The ambient temperature during production of the electrolyte solution is usually room temperature, and may be, for example, 5° C. or higher and 30° C. or lower.

In the secondary battery, the ratio (EL/S ratio) of the volume (μL) of the electrolyte solution to the weight (mg) of sulfur in the positive electrode is, from the viewpoint of further improving the discharge characteristics and the cycle characteristics, preferably 1 or more and 15 or less, more preferably 1 or more and 12 or less, yet more preferably 1 or more and 10 or less, and still more preferably 2 or more and 10 or less.

Ivan embodiment, enhanced discharge characteristics are obtained even when the amount of the electrolyte solution is decreased. The EL/S ratio is preferably 1 or more and 10 or less, more preferably 2 or more and 8 or less (particularly, 2 or more and less than 8), yet more preferably 3 or more and 8 or less (particularly, 3 or more and less than 8), and yet more preferably 4 or more and 6 or less from the viewpoint of further improving the discharge characteristics.

The EL/S ratio is preferably 5 or more and 15 or less, more preferably 8 or more and 12 or less, yet more preferably 8 or more and 11 or less, and still more preferably 9 or more and 11 or less from the viewpoint of further improving the cycle characteristics.

The positive electrode and the negative electrode are electrodes that can provide intercalation and deintercalation of lithium ions. Thus, the secondary battery is a secondary battery in which lithium ions travel between the positive electrode and the negative electrode through the electrolyte solution to enable charging and discharging of the battery. The secondary battery corresponds to a lithium ion secondary battery since lithium ions are involved in charging and discharging according to an embodiment.

The positive electrode of the secondary battery is preferably a sulfur electrode that contains at least sulfur from the viewpoint of further improving the discharge characteristics and the cycle characteristics. The sulfur electrode includes an electrode that contains sulfur (S) as an active component (in other words, an active material). For example, the sulfur electrode includes an electrode that contains at least sulfur, such as, an electrode that contains sulfur (S) such as S₈ and/or polymeric sulfur, in particular, a positive electrode containing such sulfur.

The sulfur electrode, which is an electrode that contains at least sulfur, may further contain a conductive additive and/or a binder. In such a case, the sulfur content in the sulfur electrode relative to the entire electrode (in particular, the positive electrode layer described below) is 5 wt % or more and 95 wt % or less, preferably 50 wt % or more and 90 wt % or less, and more preferably 50 wt % or more and 80 wt % or less.

Examples of the conductive additive contained in the sulfur electrode used as the positive electrode include carbon materials such as graphite, carbon fibers, carbon black, and carbon nanotubes, and one or more such carbon materials can be mixed and used. For example, vapor growth carbon fibers (VGCF, registered trademark) etc. can be used as the carbon fibers. For example, acetylene black and/or Ketjen black can be used as the carbon black. For example, single wall carbon nanotubes (SWCNT) and/or multi wall carbon nanotubes (MWCNT) such as double wall carbon nanotubes (DWCNT) can be used as the carbon nanotubes. A material other than carbon materials can be used as long as the material has excellent electrical conductivity, and examples thereof include metal materials such as Ni powder and/or conductive polymer materials. From the viewpoint of further improving the discharge characteristics and the cycle characteristics, the conductive additive is preferably carbon black and more preferably Ketjen black.

Examples of the binder contained in the sulfur electrode used as the positive electrode include fluororesins such as polyvinylidene fluoride (PVdF) and/or polytetrafluoroethylene (PTFE), polyvinyl alcohol (PVA) resins, carboxymethyl cellulose (CMC), and/or polymer resins such as styrene-butadiene copolymer rubber (SBR) resins. A conductive polymer may be used as the binder. For example, substituted or unsubstituted polyaniline, polypyrrole, polythiophene, and a (co)polymer formed from at least one selected from the foregoing can be used as the conductive polymer. From the viewpoint of further improving the discharge characteristics and the cycle characteristics, the binder is preferably SBR, CMC, or a mixture thereof, and is more preferably a mixture of SBR and CMC.

A sulfur electrode includes a positive electrode layer (in particular, may also be referred to as a sulfur-containing positive electrode layer or a sulfur positive electrode layer) and a positive electrode current collector (foil) on which the positive electrode layer is formed. In such a case, the positive electrode layer is disposed on at least one surface of the positive electrode current collector. In the positive electrode, positive electrode layers may be disposed on both surfaces of the positive electrode current collector, or a positive electrode layer may be disposed on one surface of the positive electrode current collector. From the viewpoint of further increasing the capacity of the secondary battery, preferably, the positive electrode has positive electrode layers disposed on both surfaces of the positive electrode current collector.

The positive electrode layer of the sulfur electrode may contain an additional positive electrode active material in addition to sulfur. The additional positive electrode active material may be any material that contributes to intercalation and deintercalation of lithium ions, and examples thereof include a lithium transition metal complex oxide that contains lithium and at least one transition metal selected from the group consisting of cobalt, nickel, manganese, and iron. For example, the additional positive electrode active material may be lithium cobaltate (LCO), lithium nickelate, lithium manganate, lithium titanate, or any of the foregoing with the transition metal partly substituted with a different metal. These additional positive electrode active materials may be contained alone or in combination.

A sulfur electrode can be obtained by mixing sulfur and a binder and additional components may be mixed including, for example, a conductive additive and/or an additional positive electrode active material or the like, adding an organic solvent thereto to prepare a slurry, applying the slurry to a positive electrode current collector by an appropriate coating method, and drying the applied slurry.

The positive electrode current collector used in the positive electrode is a member that contributes to collecting and supplying electrons generated by the active material resulting from battery reactions. Such a current collector may be a sheet-shaped metal member which may be porous or perforated. Examples of the current collector include metal foils, punched or perforated metals, grids, and expanded metals. The positive electrode current collector used in the positive electrode is preferably made of a metal foil that contains at least one selected from the group consisting of aluminum, stainless steel, nickel, and the like, and may be, for example, an aluminum foil.

The negative electrode is not particularly limited, but, from the viewpoint of further improving the discharge characteristics and the cycle characteristics, is preferably a metallic lithium electrode. Metallic lithium is a substance that contributes to intercalation and deintercalation of lithium ions. The metallic lithium electrode includes an electrode that contains metallic lithium (Li) as an active component (in other words, a negative electrode active material). For example, the metallic lithium electrode includes an electrode that contains metallic lithium, and an example thereof is an electrode made of lithium metal or a lithium alloy, in particular, a negative electrode made of metallic lithium (for example, elemental metallic lithium). The metallic lithium electrode may contain components other than lithium metal or a lithium alloy, and, in an embodiment, the metallic lithium electrode is an electrode composed of a lithium metal body (for example, an electrode composed of a single material of lithium metal having a purity of 90% or higher, preferably 95% or higher, and more preferably 98% or higher).

For example, the negative electrode can be produced from a plate-shaped material or a foil-shaped material, but is not limited to these, and can be produced by forming (molding) a powder.

The metallic lithium electrode (negative electrode) may be supported by a negative electrode current collector and used. For example, the metallic lithium electrode may be formed on a negative electrode current collector. The same current collector (or metal foil) as that of the positive electrode current collector can be used as the negative electrode current collector. The negative electrode current collector is preferably a copper foil from the viewpoint of further improving the discharge characteristics and the cycle characteristics.

The positive electrode and the negative electrode are alternately arranged with a separator described below therebetween. The positive electrode and the negative electrode, together with the separator described below, may have a flat multilayer structure, may have a wound structure, or may have a stack-and-folding structure. More specifically, the inside of the secondary battery may have a flat multilayer structure in which a positive electrode, a negative electrode, and a separator interposed between the positive electrode and the negative electrode are stacked in a flat layer shape, a wound structure in which a positive electrode, a negative electrode, and a separator interposed between the positive electrode and the negative electrode are wound into a roll, or a so-called stack-and-folding structure in which a positive electrode, a negative electrode, and a separator interposed between the positive electrode and the negative electrode are stacked and then folded.

A separator is a member provided from the viewpoint of preventing short-circuiting caused by contact between the positive and negative electrodes and retaining the electrolyte solution. In other words, the separator is a member that allows ions to pass while preventing electronic contact between the positive electrode and the negative electrode. In an embodiment, the separator is a porous or microporous insulating member, and may have a film shape due to a small thickness.

The separator may be an inorganic separator or an organic separator. Examples of the inorganic separator include glass filters and glass fibers. Examples of the organic separator include synthetic resin porous films made of polytetrafluoroethylene, polypropylene and/or polyethylene, and the like, and the organic separator may have a structure in which two or more such porous films are stacked. In particular, a polyolefin porous film is preferable for its excellent short-circuiting-preventing effect and its ability to improve safety of batteries by the shut-down effect.

The outer casing may be a flexible pouch (flexible bag body) or a hard case (rigid casing).

When the outer casing is a flexible pouch, a typical flexible pouch is made from a laminate film, and a seal portion is formed by heat-sealing the peripheral edges. A film formed by stacking a metal foil and a polymer film is a typical laminate film, and one specific example thereof is a three-layer-structure film constituted by an outer layer polymer film, a metal foil, and an inner layer polymer film. The outer layer polymer film is for preventing damage on the metal foil inflicted by permeation, contact, etc., of water and the like, and a polymer such as polyamide or a polyester is preferably used. The metal foil is for preventing permeation of water and gas, and foils of copper, aluminum, stainless steel, etc., are preferably used. The inner layer polymer film is for protecting the metal foil from the electrolyte housed inside and for melt-sealing the openings during heat sealing, and a polyolefin or an acid-modified polyolefin is preferably used. The thickness of the laminate film is not particularly limited and may be, for example, 1 μm or more and 1 mm or less. When the outer casing is a flexible pouch, the peripheral edges of the secondary battery in a plan view are heat-sealed.

When the outer casing is a hard case, the hard case is usually formed from a metal plate, and a seal portion is formed by irradiating the peripheral edges with a laser. Usually, a metal material composed of aluminum, nickel, iron, copper, a stainless steel, or the like is used as the metal plate. The thickness of the metal plate is not particularly limited and may be, for example, 1 μm or more and 1 mm or less.

Hereinafter, examples of a cylindrical secondary battery and a flat-plate-type laminate film-type secondary battery are described according to an embodiment.

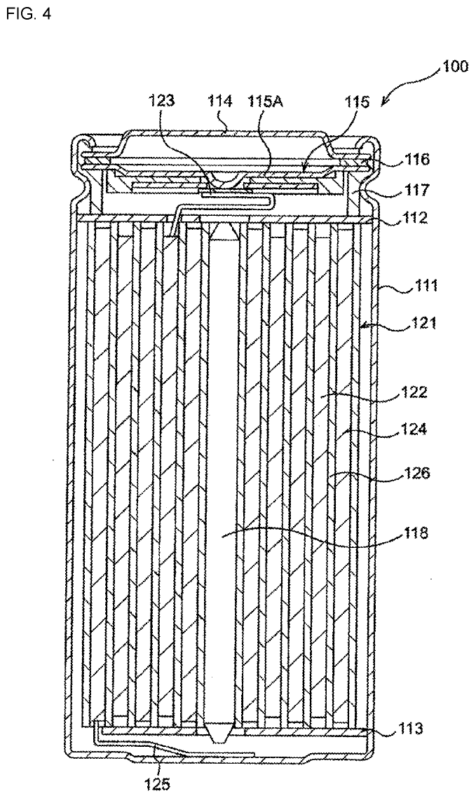

FIG. 4 is a schematic cross-sectional view of a cylindrical secondary battery 100. In the secondary battery 100, an electrode structure 121 and a pair of insulating plates 112 and 113 are housed in an electrode structure housing member 111 that is substantially hollow and cylindrical. The electrode structure 121 can be prepared by, for example, stacking a positive electrode 122 and a negative electrode 124 with a separator 126 therebetween to obtain an electrode structure, and then winding the electrode structure. The electrode structure housing member (for example, a battery can) 111 has a hollow structure having one end portion closed and the other end portion open, and is made from iron (Fe) and/or aluminum (Al) or the like. The pair of insulating plates 112 and 113 sandwich the electrode structure 121 and are arranged to extend perpendicular to the winding peripheral surface of the electrode structure 121. To an open end portion of the electrode structure housing member 111, a battery lid 114, a safety valve mechanism 115, and a heat-sensitive resistance element (for example, a positive temperature coefficient (PTC) element) 116 are crimped with a gasket 117 therebetween, and this keeps the electrode structure housing member 111 sealed. The battery lid 114 is, for example, made from the same material as the electrode structure housing member 111. The safety valve mechanism 115 and the heat-sensitive resistance element 116 are disposed inside the battery lid 114, and the safety valve mechanism 115 is electrically coupled with the battery lid 114 via the heat-sensitive resistance element 116. In the safety valve mechanism 115, a disk plate 115A flips once the internal pressure increases to a particular level or higher due to internal short-circuiting and/or heating from outside, etc. This cuts the electrical coupling between the battery lid 114 and the electrode structure 121. In order to prevent abnormal heat attributable to large current, the resistance of the heat-sensitive resistance element 116 increases with the increase in temperature. The gasket 117 is made of, for example, an insulating material. The surface of the gasket 117 may be coated with asphalt or the like.

A center pin 118 is inserted into the center of the winding of the electrode structure 121. However, insertion of the center pin 118 into the center of the winding is optional. A positive electrode lead portion 123 made of a conductive material such as aluminum is connected to the positive electrode 122. Specifically, the positive electrode lead portion 123 is attached to a positive electrode (for example, a positive electrode current collector). A negative electrode lead portion 125 made of a conductive material such as copper is connected to the negative electrode 124. Specifically, the negative electrode lead portion 125 is attached to a negative electrode (for example, a negative electrode current collector). The negative electrode lead portion 125 is welded to the electrode structure housing member 111 and is electrically coupled with the electrode structure housing member 111. The positive electrode lead portion 123 is welded to the safety valve mechanism 115 and is electrically coupled with the battery lid 114. In the example illustrated in FIG. 4, the negative electrode lead portion 125 is provided at one position (the outermost peripheral portion of the wound electrode structure); alternatively, the negative electrode lead portion 125 may be provided at two positions (the outermost peripheral portion and the inner most peripheral portion of the wound electrode structure).

The electrode structure 121 is obtained by stacking the positive electrode 122 and the negative electrode 124 with the separator 126 therebetween. When the positive electrode includes a positive electrode layer and a positive electrode current collector (foil), a region where the positive electrode (for example, the positive electrode current collector) is attached to the positive electrode lead portion 123 has no positive electrode layer formed therein.

The secondary battery 100 can be produced by, for example, the following procedure.

First, a sulfur electrode (positive electrode) and a metallic lithium electrode (negative electrode) are prepared. For example, sulfur-containing positive electrode layers are formed on both surfaces of the positive electrode current collector to obtain a positive electrode. A metallic lithium foil material is cut out to obtain a negative electrode.

Next, a welding method or the like is employed to attach the positive electrode lead portion 123 to the positive electrode current collector. Then a welding method or the like is employed to attach the negative electrode lead portion 125 to the negative electrode current collector. Next, the positive electrode 122 and the negative electrode 124 are stacked with the separator 126 made of a microporous polyethylene film therebetween, the resulting stack is wound (more specifically, a positive electrode 122/separator 126/negative electrode 124/separator 126 electrode structure (in other words, a multilayer structure) is wound) to prepare an electrode structure 121, and then a protection tape (not illustrated) is bonded onto the outermost peripheral portions. Then the center pin 118 is inserted into the center of the electrode structure 121. Next, the electrode structure 121 sandwiched between a pair of insulating plates 112 and 113 is placed in the electrode structure housing member 111. In this case, a welding method or the like is employed to attach the tip portion of the positive electrode lead portion 123 to the safety valve mechanism 115 and attach the tip portion of the negative electrode lead portion 125 to the electrode structure housing member 111. Subsequently, the electrolyte solution is poured by a depressurizing method to impregnate the separator 126 with the electrolyte solution. Next, the battery lid 114, the safety valve mechanism 115, and the heat-sensitive resistance element 116 are crimped to the opening end portion of the electrode structure housing member 111 with the gasket 117 therebetween.

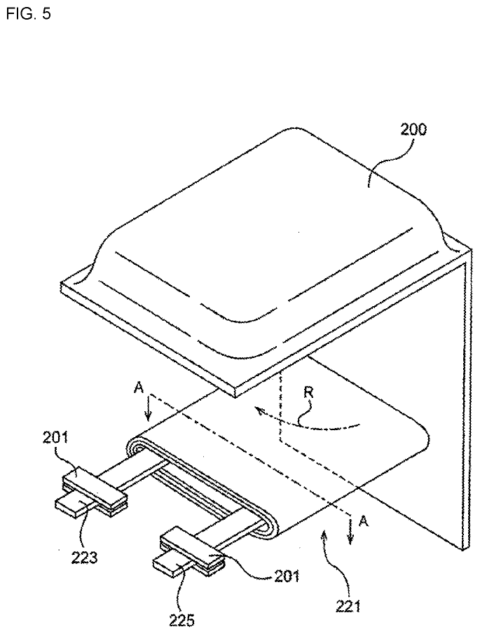

Next, a flat-plate-type laminate film-type secondary battery is described. A schematic exploded perspective view of this secondary battery is illustrated in FIG. 5. In this secondary battery, an electrode structure 221 basically identical to that described above is housed in an outer casing member 200 made of a laminate film. The electrode structure 221 can be prepared by stacking a positive electrode and a negative electrode with a separator therebetween to obtain an electrode structure, and then winding the electrode structure. A positive electrode lead portion 223 is attached to the positive electrode, and a negative electrode lead portion 225 is attached to the negative electrode. The outermost peripheral portion of the electrode structure 221 is protected with a protection tape.

The positive electrode lead portion 223 and the negative electrode lead portion 225 project outward in the same direction from the interior of the outer casing member 200. The positive electrode lead portion 223 is made of a conductive material such as aluminum. The negative electrode lead portion 225 is made of a conductive material such as copper, nickel, and/or stainless steel.

The outer casing member 200 is one film that can be folded in the arrow R direction in FIG. 5, and a recess (for example, an embossed part) for housing the electrode structure 221 is formed in one portion of the outer casing member 200. The outer casing member 200 is, for example, a laminate film in which a fusion-bonding layer, a metal layer, and a surface protection layer are stacked in this order. In the secondary battery production process, the outer casing member 200 is folded so as to have the fusion layers face each other with the electrode structure 221 therebetween, and then the outer peripheral edges of the fusion-bonding layers are fusion-bonded. Alternatively, the outer casing member 200 may be two separate laminate films bonded with an adhesive or the like. The fusion-bonding layer is, for example, composed of a film of polyethylene and/or polypropylene. The metal layer is, for example, made of an aluminum foil or the like. The surface protection layer is made of, for example, nylon and/or polyethylene terephthalate or the like. In particular, the outer casing member 200 is preferably an aluminum laminate film in which a polyethylene film, an aluminum foil, and a nylon film are stacked in this order. However, the outer casing member 200 may be any laminate film having any other multilayer structure, a polymer film such as polypropylene, or a metal film. Specifically, the outer casing member 200 may be a moisture-resistant aluminum laminate film in which a nylon film, an aluminum foil, and an unstretched polypropylene film are stacked in this order from the outer side portion.

In order to prevent entry of outside air, contact films 201 are inserted between the outer casing member 200 and the positive electrode lead portion 223 and between the outer casing member 200 and the negative electrode lead portion 225. The contact films 201 may be made of a material that makes close contact with the positive electrode lead portion 223 and the negative electrode lead portion 225, for example, a polyolefin resin, more specifically, a polyolefin resin such as polyethylene, polypropylene, modified polyethylene, or modified polypropylene.

### EXAMPLES

Examples of the present application are provided below according to an embodiment.

### [Reagents]

Following reagents were used.
LiTFSI (lithium bistrifluoromethanesulfonylimide): produced by TOMIYAMA PURE CHEMICAL INDUSTRIES, LTD.
Lithium nitrate (LiNO₃): produced by Kanto Chemical CO., INC.
Dimethoxyethane (DME): produced by TOMIYAMA PURE CHEMICAL INDUSTRIES, LTD.
Hydrofluoroether (HFE): produced by DAIKIN INDUSTRIES, LTD. (corresponding to the compound (e1-1-2))(viscosity: 1.6 mPa, permittivity: 6.4, boiling point: 92° C.)

### Example 1

Preparation of Electrolyte Solution

To 1 L of dimethoxyethane (DME), LiTFSI was added to yield 1 mol/L and LiNO₃ was added to yield 1 mol/L, and the resulting mixture was stirred to obtain a solution A.

The solution A was diluted with HFE so that solution A:HFE=3:1 (volume ratio) so as to obtain an electrolyte solution (dilution rate: 25%).

Preparation of Laminate Cell

A composite body of sulfur, Ketjen black, and a binder (styrene butadiene rubber (SBR) and carboxymethyl cellulose (CMC)) was dispersed in a solvent mainly composed of water to prepare a slurry, and the slurry was applied to an Al foil and dried to obtain a positive electrode. The sulfur content of the positive electrode layer was 66 wt %.

A Li metal foil (with a copper current collector foil) was prepared as a negative electrode. The purity of Li in the Li metal foil was 99.9%.

A polyethylene separator was prepared as the separator.

The separator was interposed between the positive electrode and the negative electrode to obtain a multilayer body. The multilayer body was placed in a laminate outer casing, and the electrolyte solution was poured. While removing air from the interior of the outer casing, the opening was heat-sealed. The positive electrode and the separator were thoroughly impregnated with the electrolyte solution by hydrostatic pressure impregnation. The cell was held by a pressure jig to obtain a laminate cell. In the laminate cell, the ratio (EL/S ratio) of the weight of the electrolyte solution to the weight of sulfur in the positive electrode was 5.

### Example 2

An electrolyte solution and a laminate cell were obtained as in Example 1 except that the solution A was diluted with HFE (dilution rate: 50%) so that solution A:HFE=1:1 (volume ratio).

### Comparative Example 1

A laminate cell was obtained in as Example 1 except that the solution A was directly used as the electrolyte solution without dilution.

### [Measurement of Discharge Capacity (Discharge Characteristics)]

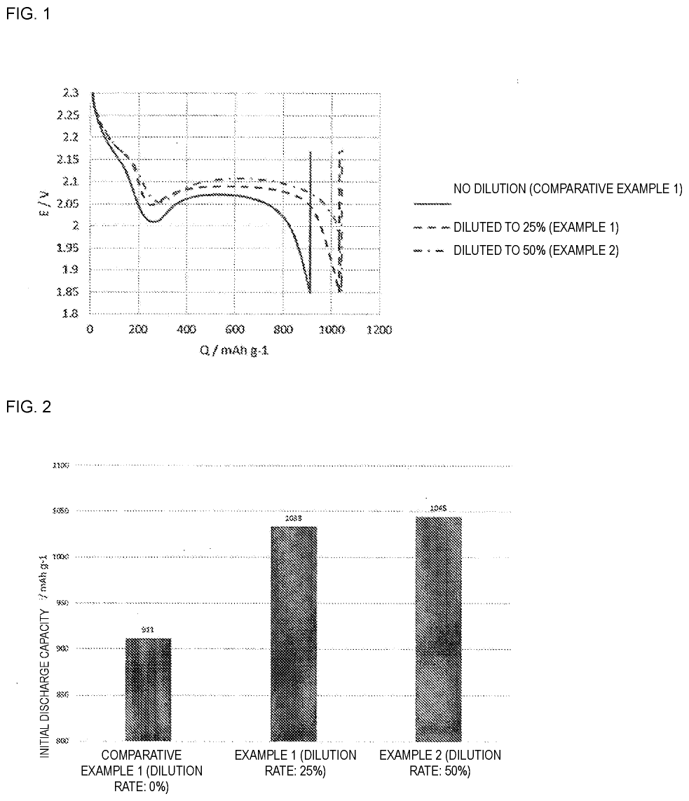

Charging and discharging were conducted under the following conditions, and an initial charge-discharge curve was plotted as illustrated in FIG. 1. The relationship between the initial discharge capacity and the dilution rate is illustrated in FIG. 2.

Stand-by time: 2 hours
Cut-off potential: 2.8 to 1.85 V (CC discharge·CC/CV discharge)
Intermission: 10 minutes (after each charging and discharging)
Rate: 0.2 C (calculated on the assumption that the discharge capacity was 1000 mAh/g)
Amount of electrolyte solution: EL/S ratio=5 (EL/S ratio: ratio of the amount of the electrolyte solution [μL] to the amount of sulfur [mg])
The cell was pressurized with a jig to 5 cN·m.

It was found that dilution increased the discharge capacity. It was found that, by diluting 2 mol/L of the electrolyte solution with a fluorinated ether, the discharge capacity can be retained and can even be increased even when the amount of the electrolyte solution is small. Thus, a battery design with a low EL/S is possible, and the energy density can be improved.

The factors under which the discharge capacity increases by dilution are probably (1) and/or (2) below.
Factor (1): Since the viscosity of the electrolyte solution decreases and the load characteristics are improved, the cut-off potential is not easily reached, and the discharge capacity increases as a result.
Factor (2): The electrolyte solution reaches deeper portions of the pores, and the utility rate of the active material increases.

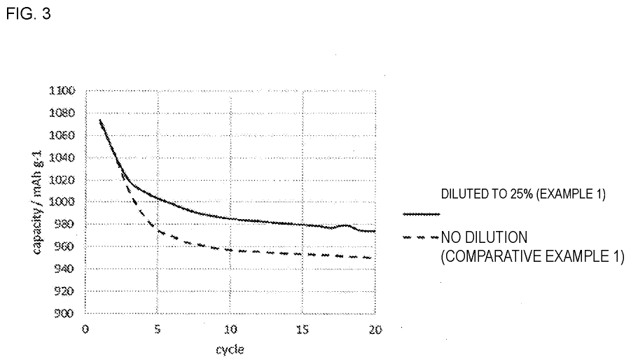

For the cells that used the electrolyte solutions of Example 1 and Comparative Example 1, charging and discharging were performed 20 times, and the transition of the discharge capacity is illustrated in FIG. 3. The cells that used the electrolyte solutions of Example 1 and Comparative Example 1 are laminate cells obtained as in Example 1 and Comparative Example 1 except that the EL/S ratio was 10.

It was found that dilution increased the discharge capacity retention rate.

A secondary battery according to the present application can be used in a number of suitable applications according to an embodiment. For example, a secondary battery according to the present application can be used in variety of fields for which battery usage or power storage are anticipated. Further, the secondary battery of the present application can be used in the electronics packaging field. Furthermore, the secondary battery according to the present application can find usage in electrical, information, and communication fields involving mobile appliances (for example, the electrical and electronic appliance fields and mobile device fields including small electronic appliances such as cellular phones, smart phones, laptop computers, digital cameras, activity trackers, arm computers, electronic papers, wearable devices, RFID tags, card-type electronic money, and smart watches), home and small-scale industry usages (for example, the fields of power tools, golf carts, and robots for household use, caregiving, and industrial use), large-scale industry usages (for example, the fields of forklifts, elevators, and harbor cranes), traffic system fields (for example, the fields of hybrid cars, electric cars, buses, trains, power-assisted bicycles, and two-wheeled electric vehicles), power system usages (for example, various types of power generation, load conditioners, smart grids, and general home installation electricity storage systems), medical usages (the fields of medical devices such as hearing aid earbuds), medicine usages (the fields of medicine dosage management systems), IoT fields, and space and deep-see usages (for example, the fields of space probes and submersible research vehicles).

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrolyte solution for a secondary battery, comprising:
an electrolyte and a solvent,
wherein the electrolyte includes a sulfonyl group-containing lithium salt and lithium nitrate,
a total content of the sulfonyl group-containing lithium salt and the lithium nitrate is 0.8 mol/L or more and 2.0 mol/L or less, and
the solvent includes a straight-chain ether and a fluorinated ether.

2. The electrolyte solution according to claim 1, wherein the fluorinated ether is a straight-chain or cyclic ether compound that includes a fluorine atom and an ether bond.

3. The electrolyte solution according to claim 1, wherein the fluorinated ether is at least one compound selected from the group consisting of a straight-chain ether compound represented by a general formula (E1) below and a cyclic ether compound represented by a general formula (E2) below: 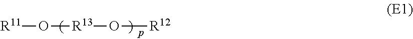
in formula (E1), one or both of R¹¹ and R¹² is a fluorine atom-containing monovalent hydrocarbon group having 1 to 10 carbon atoms; R¹¹ is a fluorine atom-containing monovalent hydrocarbon group and R¹² is a monovalent hydrocarbon group having 1 to 10 carbon atoms, or R¹² is a fluorine atom-containing monovalent hydrocarbon group and R¹¹ is a monovalent hydrocarbon group having 1 to 10 carbon atoms;
R¹³ is a divalent hydrocarbon group having 2 to 4 carbon atoms; and
p is an integer of 0 or 1 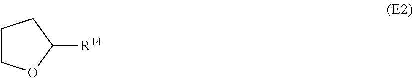
in formula (E2), R¹⁴ is a fluorine atom-containing monovalent hydrocarbon group having 1 to 10 carbon atoms.

4. The electrolyte solution according to claim 3, wherein the fluorine atom-containing monovalent hydrocarbon group is a hydrocarbon group represented by a general formula (F) below: 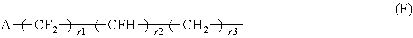
in formula (F), A is hydrogen atom or a fluorine atom;
r1 is an integer of 0 or more and 10 or less; r2 is an integer of 0 or more and 10 or less; r3 is an integer of 0 or more and 9 or less; r1+r2 is an integer of 1 or more and 10 or less; r1+r2+r3 is an integer of 1 or more and 10 or less; and difluoroethylene units related to r1, monofluoroethylene units related to r2, and ethylene units related to r3 may be arranged at random.

5. The electrolyte solution according to claim 1, wherein a content of the fluorinated ether relative to a total amount of the straight-chain ether and the fluorinated ether is 20 vol % or more and 60 vol % or less.

6. The electrolyte solution according to claim 1, wherein the straight-chain ether is a straight-chain ether represented by a general formula (G) below: 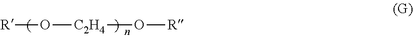
in formula (G), R′ and R″ are each independently a hydrocarbon group having 1 to 10 carbon atoms; and n is an integer of 1 or more and 10 or less.

7. The electrolyte solution according to claim 1, wherein the sulfonyl group-containing lithium salt is at least one compound selected from the group consisting of a sulfonylimide lithium salt represented by a general formula (S1) below and a lithium sulfonate represented by a general formula (S2) below: 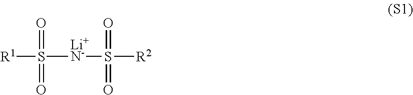
in formula (S1), R¹ are R² are each independently a halogen atom or a halogen atom-containing hydrocarbon group having 1 to 10 carbon atoms; and 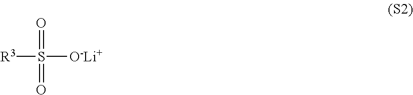
in formula (S2), R³ is a halogen atom or a halogen atom-containing hydrocarbon group having 1 to 10 carbon atoms.

8. The electrolyte solution according to claim 1, wherein a content of the sulfonyl group-containing lithium salt is 0.1 mol/L or more and 1.0 mol/L or less.

9. The electrolyte solution according to claim 1, wherein a content of the lithium nitrate is 0.1 mol/L or more and 1.0 mol/L or less.

10. The electrolyte solution according to claim 1, wherein the secondary battery includes, as a positive electrode, a sulfur electrode containing sulfur.

11. The electrolyte solution according to claim 10, wherein a ratio (EL/S ratio) of a weight of the electrolyte solution to a weight of sulfur in the positive electrode in the secondary battery is 1 or more and 10 or less.

12. The electrolyte solution according to claim 1, wherein the secondary battery includes a negative electrode including a metallic lithium.

13. The electrolyte solution according to claim 1, wherein the secondary battery is a lithium ion secondary battery.

14. A method for producing an electrolyte solution for a secondary battery, the method comprising dissolving a sulfonyl group-containing lithium salt and a lithium nitrate in a straight-chain ether to form a solution and then diluting the solution with a fluorinated ether to adjust a total content of the sulfonyl group-containing lithium salt and the lithium nitrate to 0.8 mol/L or more and 2.0 mol/L or less to form a diluted solution.

15. The method for producing an electrolyte solution according to claim 14, wherein an electrolyte of the electrolyte solution is produced from the diluted solution.

16. A secondary battery comprising the electrolyte solution according to claim 1.
